(19) United States
(12) Patent Application Publication
(10) Pub. No.: US 2024/0095520 A1
(43) Pub. Date: Mar. 21, 2024

(54) REPRESENTATION LEARNING APPARATUS, METHOD, AND NON-TRANSITORY COMPUTER READABLE MEDIUM

(71) Applicant: KABUSHIKI KAISHA TOSHIBA, Tokyo (JP)

(72) Inventors: Kentaro TAKAGI, Yokohama Kanagawa (JP); Toshiyuki Oshima, Tokyo (JP)

(73) Assignee: KABUSHIKI KAISHA TOSHIBA, Tokyo (JP)

(21) Appl. No.: 18/176,159

(22) Filed: Feb. 28, 2023

(30) Foreign Application Priority Data
Sep. 15, 2022 (JP) 2022-147323

(51) Int. Cl. G06N 3/08; G06N 3/045

(52) U.S. Cl. CPC G06N 3/08; G06N 3/045

(57) ABSTRACT

A representation learning apparatus executing: calculating a latent vector Sx in a latent space of the target data x using a first model parameter, calculate a non-interest latent vector Zx in a latent space of an non-interest feature included in the target data x and a non-interest latent vector Zb in the latent space of a non-interest data using a second model parameter, calculate a similarity S1 obtained by correcting a similarity between the latent vector Sx and its representative value S′x by a similarity between the latent vector Zx and its representative value Z′x, and a similarity S2 between the latent vector Zb and its representative value Z′b, and update the first and/or the second model parameter based on the loss function including the similarity S1 and S2.

### CROSS-REFERENCE TO RELATED APPLICATIONS

This application is based upon and claims the benefit of priority from Japanese Patent Application No. 2022-147323, filed Sep. 15, 2022, the entire contents of which are incorporated herein by reference.

### FIELD

Embodiments described herein relate generally to a representation learning apparatus, a method, and a non-transitory computer readable medium.

### BACKGROUND

In recent machine learning, a method of representation learning for representing complex data such as image data, audio data, or time-series data using a low-dimensional feature amount vector has been proposed. As an example, a representation learning method suitable for clustering has been proposed. In this method, since a feature amount for clustering complex/abstract information samples that can be grouped is learned, a feature amount that clusters both features that should be focused and features that should not be focused is learned.

### BRIEF DESCRIPTION OF THE DRAWINGS

FIG. 1 is a view showing an example of the configuration of a representation learning apparatus according to the embodiment.

FIG. 2 is a view showing an example of target data.

FIG. 3 is a view showing another example of target data.

FIG. 4 is a flowchart showing an example of the processing procedure of representation learning processing according to the embodiment.

FIG. 5 is a view showing various kinds of constituent elements and the flow of data associated with the representation learning processing shown in FIG. 4.

FIG. 6 is a view showing an example of target data used in the representation learning processing shown in FIGS. 4 and 5.

FIG. 7 is a view showing an example of non-interest data corresponding to FIG. 6.

FIG. 8 is a flowchart showing the processing procedure of clustering according to Use Example 1.

FIG. 9 is a view showing clustering accuracies in the embodiment and a comparative example.

FIG. 10 is a view showing the results of compressing data distributions on latent spaces according to the embodiment and a comparative example into two dimensions and visualizing these.

FIG. 11 is a flowchart showing the processing procedure of clustering according to Use Example 2.

FIG. 12 is a flowchart showing the processing procedure of clustering according to Use Example 3.

FIG. 13 is a flowchart showing the processing procedure of clustering according to Use Example 4.

FIG. 14 is a flowchart showing the processing procedure of search processing according to Use Example 5.

FIG. 15 is a flowchart showing the processing procedure of search processing according to Use Example 6.

FIG. 16 is a flowchart showing the processing procedure of search processing according to Use Example 7.

FIG. 17 is a flowchart showing the processing procedure of search processing according to Use Example 8.

### DETAILED DESCRIPTION

A representation learning apparatus according to the embodiment includes a first acquisition unit, a second acquisition unit, a first vector calculation unit, a second vector calculation unit, a similarity calculation unit, a loss function calculation unit, and an updating unit. The first acquisition unit acquires target data. The second acquisition unit acquires non-interest data similar to a non-interest feature included in the target data. The first vector calculation unit calculates a latent vector in the latent space of the target data using a first model parameter concerning a first machine learning model of a training target. The second vector calculation unit calculates a first non-interest latent vector in the latent space of the non-interest feature in the target data and a second non-interest latent vector in the latent space of the non-interest data using a second model parameter concerning a second machine learning model of the training target. The similarity calculation unit calculates a first similarity obtained by correcting the similarity between the latent vector and a first representative value of the latent vector by the similarity between the first non-interest latent vector and a second representative value of the first non-interest latent vector, and a second similarity between the second non-interest latent vector and a third representative value of the second non-interest latent vector. The loss function calculation unit calculates a loss function including the first similarity and the second similarity. The updating unit updates the first model parameter and/or the second model parameter based on the loss function.

A representation learning apparatus, a method, and a non-transitory computer readable medium according to this embodiment will now be described with reference to the accompanying drawings.

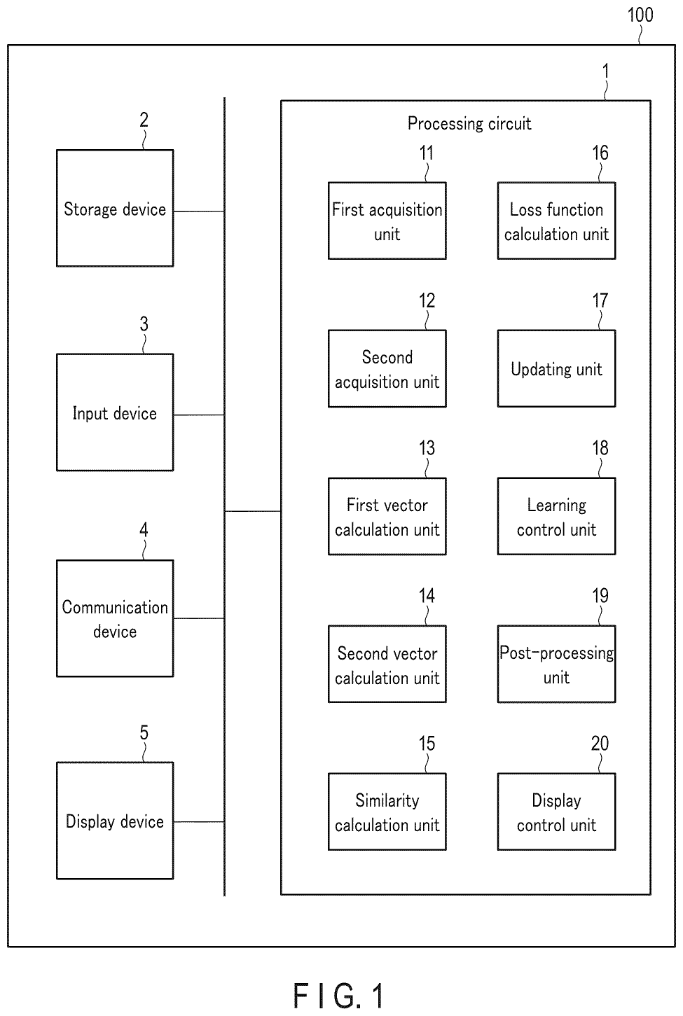

FIG. 1 is a view showing an example of the configuration of a representation learning apparatus 100 according to this embodiment. As shown in FIG. 1, the representation learning apparatus 100 is a computer including a processing circuit 1, a storage device 2, an input device 3, a communication device 4, and a display device 5. Data communication between the processing circuit 1, the storage device 2, the input device 3, the communication device 4, and the display device 5 is performed via a bus.

The processing circuit 1 includes a processor such as a CPU (Central Processing Unit), and a memory such as a RAM (Random Access Memory). The processing circuit 1 includes a first acquisition unit 11, a second acquisition unit 12, a first vector calculation unit 13, a second vector calculation unit 14, a similarity calculation unit 15, a loss function calculation unit 16, an updating unit 17, a learning control unit 18, a post-processing unit 19, and a display control unit 20. The processing circuit 1 executes a representation learning program, thereby implementing the functions of the units 11 to 20. The representation learning program is stored in a non-transitory computer readable medium such as the storage device 2. The representation learning program may be implemented as a single program that describes all the functions of the units 11 to 20, or may be implemented as a plurality of modules divided into several functional units. In addition, the units 11 to 20 may be implemented by an integrated circuit such as Application Specific Integrated Circuit (ASIC). In this case, the units may be implemented on a single integrated circuit, or may be implemented individually on a plurality of integrated circuits.

The first acquisition unit 11 acquires processing target learning data (to be referred to as target data hereinafter). The target data means data of a classification target by a machine learning model. The target data has a feature that should be focused (to be referred to as a interest feature hereinafter), and a feature that should not be focused (to be referred to as a non-interest feature hereinafter). The target data is not particularly limited if it can be classified and, for example, image data, audio data, character data, waveform data, and the like are used.

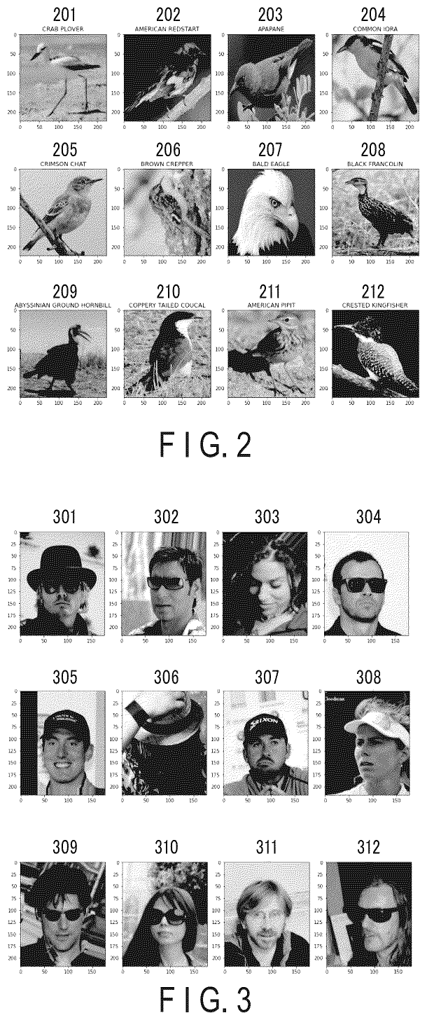

Detailed examples of target data will be described here with reference to FIGS. 2 and 3.

FIG. 2 is a view showing an example of target data. The target data shown in FIG. 2 are optical images (to be referred to as bird images hereinafter) 201 to 212 in which birds are drawn. The bird images 201 to 212 are parts of a data set called Birds 400. As an example, interest features in the bird images correspond to bird portions shown in the images 201 to 212. As an example, non-interest features correspond to backgrounds such as the sky, trees, and ground shown in the images 201 to 212.

FIG. 3 is a view showing another example of target data. The target data shown in FIG. 3 are optical images (to be referred to as person images hereinafter) 301 to 312 in which person faces are drawn. As an example, interest features in the person images correspond to hair colors, mustaches, and mouths shown in the images 301 to 312. As an example, non-interest features correspond to eyeglasses and hats shown in the images 301 to 312. The second acquisition unit 12 acquires non-interest data that is data similar to a non-interest feature included in target data. Like target data, non-interest data b is not particularly limited if it can be classified and, for example, image data, audio data, text data, waveform data, and the like are used.

The first vector calculation unit 13 calculates a latent vector in the latent space of target data using a first model parameter of a first machine learning model of a training target. The latent vector is a vector representing data obtained by compressing the dimensions of the target data. The latent space means a space established by the latent vector. The first machine learning model is an encoder network that converts the target data into the latent vector. The first model parameter is a parameter of the training target assigned to the first machine learning model. Typically, the first model parameter is a weight or a bias. The first model parameter is stored in the storage device 2.

The second vector calculation unit 14 calculates a latent vector (to be referred to as a first non-interest latent vector hereinafter) in the latent space of a non-interest feature of target data using a second model parameter of a second machine learning model of the training target. Also, the second vector calculation unit 14 calculates a second non-interest latent vector in the latent space of the non-interest data using the second model parameter. If the first non-interest latent vector and the second non-interest latent vector are not discriminated, these will simply be referred to as non-interest latent vectors hereinafter. The latent space concerning the second machine learning model means a space established by the latent vector of non-interest. The second machine learning model is an encoder network that converts the non-interest feature of the target data or the non-interest data into the first non-interest latent vector and the second non-interest latent vector. The second model parameter is a parameter of the training target assigned to the second machine learning model. Typically, the second model parameter is a weight or a bias. The second model parameter is stored in the storage device 2. Note that the first machine learning model and the second machine learning model may be of the same type or different types.

The similarity calculation unit 15 calculates a first similarity obtained by correcting the similarity between a latent vector and a first representative value of the latent vector by the similarity between a first non-interest latent vector and a second representative value of the first non-interest latent vector. The first representative value is a value representing a plurality of latent vectors obtained until the preceding iteration count in representation learning processing. Similarly, the second representative value is a value representing a plurality of first non-interest latent vectors obtained until the preceding iteration count in representation learning processing. In addition, the similarity calculation unit 15 calculates a second similarity between a second non-interest latent vector and a third representative value of the second non-interest latent vector. The third representative value is a value representing a plurality of second non-interest latent vectors obtained until the preceding iteration count in representation learning processing. Furthermore, the similarity calculation unit 15 may calculate a third similarity between the first non-interest latent vector and the third representative value.

The loss function calculation unit 16 calculates a loss function including at least the first similarity and the second similarity. If the third similarity is calculated, the loss function calculation unit 16 may calculate a loss function including the first similarity, the second similarity, and the third similarity.

The updating unit 17 updates the first model parameter and/or the second model parameter based on the loss function. More specifically, the updating unit 17 updates the first model parameter and/or the second model parameter in accordance with the gradient of the loss function.

The learning control unit 18 controls representation learning processing. More specifically, the learning control unit 18 determines whether a stop condition of representation learning processing is satisfied, and iterates the representation learning processing until it is determined that the stop condition is satisfied. Upon determining that the stop condition of representation learning processing is satisfied, the learning control unit 18 outputs the first model parameter and/or the second model parameter in the current iteration count as a learned model parameter.

The post-processing unit 19 executes post-processing using an information resource obtained by representation learning processing. More specifically, clustering processing and search processing are executed as post-processing. In clustering processing, target data or new data are clustered using latent vectors and/or non-interest latent vectors obtained by representation learning processing. In search processing, another target data or new data similar to target data or new data as a reference is searched for using latent vectors and/or non-interest latent vectors obtained by representation learning processing.

The display control unit 20 displays various data on the display device 5. For example, the display control unit 20 displays a result of clustering using a machine learning model.

The storage device 2 is formed by a ROM (Read Only Memory), an HDD (Hard Disk Drive), an SSD (Solid State Drive), and integrated circuit storage device, or the like. The storage device 2 stores the representation learning program, and the like. Also, the storage device 2 stores the latent vector of the target data and the first representative value thereof, the latent vector of non-interest of the target data and the second representative value thereof, and the latent vector of non-interest of non-interest data and the third representative value thereof.

The input device 3 inputs various kinds of instructions from a user. As the input device 3, a keyboard, a mouse, various kinds of switches, a touch pad, a touch panel display, or the like can be used. An output signal from the input device 3 is supplied to the processing circuit 1. Note that the input device 3 may be an input device of a computer connected to the processing circuit 1 by wire or wirelessly.

The communication device 4 is an interface configured to perform data communication with an external device connected to the representation learning apparatus 100 via a network.

The display device 5 displays various kinds of information. For example, the display device 5 displays various kinds of data under the control of the display control unit 20. As the display device 5, a CRT (Cathode-Ray Tube) display, a liquid crystal display, an organic EL (Electro Luminescence) display, an LED (Light-Emitting Diode) display, a plasma display, or any other arbitrary display known in this technical field can appropriately be used. Also, the display device 5 may be a projector.

Representation learning processing according to this embodiment will be described below.

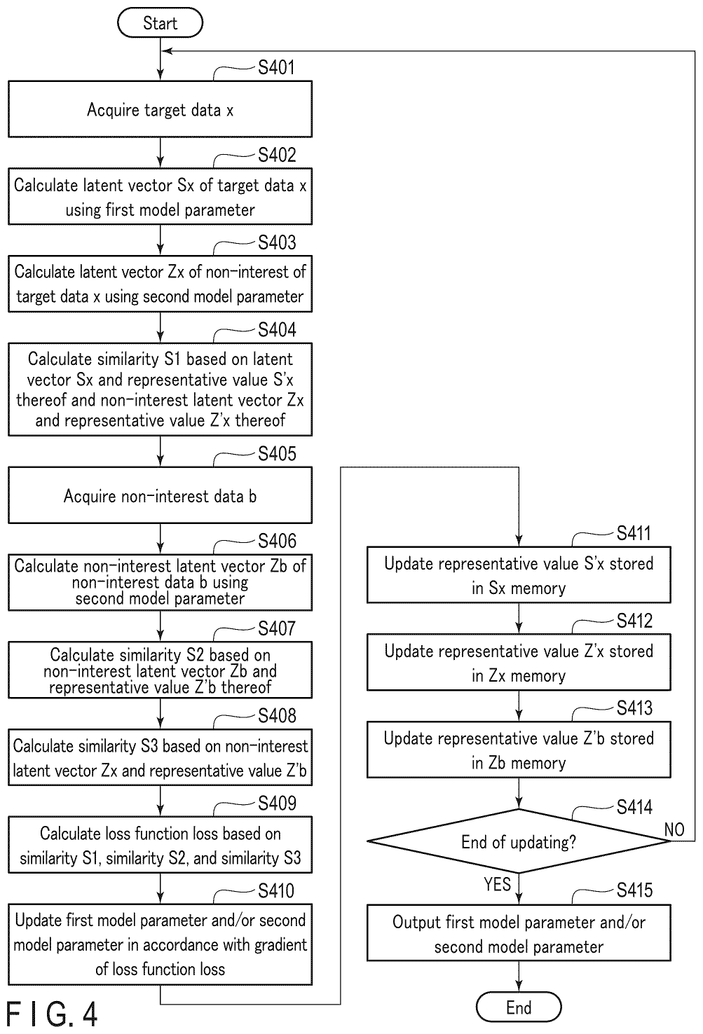

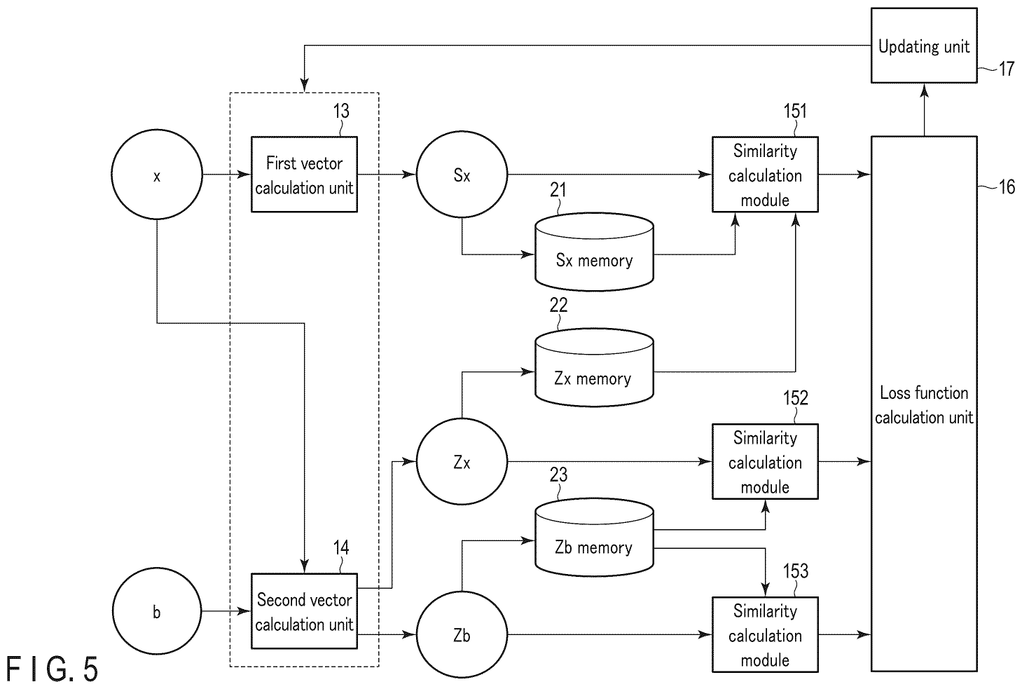

FIG. 4 is a flowchart showing an example of the processing procedure of representation learning processing according this the embodiment. FIG. 5 is a view showing various kinds of constituent elements and the flow of data associated with the representation learning processing shown in FIG. 4. An Sx memory 21 shown in FIG. 5 is a memory that is a part of the storage device 2 and stores the latent vector and the first representative value. A Zx memory 22 is a memory that is a part of the storage device 2 and stores the first non-interest latent vector and the second representative value. A Zb memory 23 is a memory that is a part of the storage device 2 and stores the second non-interest latent vector and the third representative value. A similarity calculation module 151 is a part of the similarity calculation unit 15 and calculates the first similarity. A similarity calculation module 152 is a part of the similarity calculation unit 15 and calculates the second similarity. A similarity calculation module 153 is a part of the similarity calculation unit 15 and calculates the third similarity.

As shown in FIGS. 4 and 5, the first acquisition unit 11 acquires target data x (step S401). In step S401, the first acquisition unit 11 acquires N target data xᵢ. N is a natural number of 2 or more, and a detailed value is arbitrarily set. The N target data xᵢ and M data bᵢ of non-interest to be described later form one mini batch. The suffix i represents ith target data x and ith non-interest data b. Note that the numbers N and M may be the same or different.

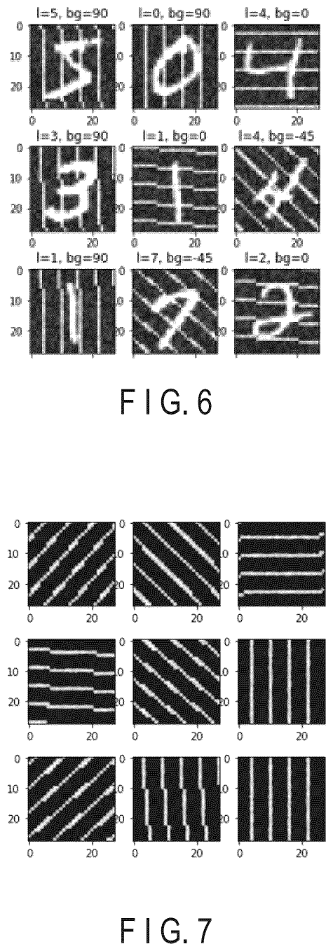

FIG. 6 is a view showing an example of target data used in the representation learning processing shown in FIGS. 4 and 5. As shown in FIG. 6, the target data are images in which digits “0” to “9” are drawn with stripe patterns at various angles on the background. In FIG. 6, l represents the value of a digit drawn in an image, that is, a label, and bg represents the angle of a stripe pattern. For example, in the image at the upper left corner, l=5, and bg=90, and this means an image in which a digit “5” is drawn with a stripe pattern at 90°. Here, the digit is a interest feature, and the stripe pattern is a non-interest feature. The target data corresponds to, for example, a defect inspection image in which a defective article is drawn.

In step S401, the first acquisition unit 11 may perform data extension for the target data xᵢ. As an example, random image cropping or a method of changing brightness, lightness, saturation, or the like at random is performed as the data extension.

When step S401 is performed, the first vector calculation unit 13 calculates a latent vector Sxᵢ of the target data x₁ using the first model parameter (step S402). The first vector calculation unit 13 reads out the first model parameter of the training target from the storage device 2, sets the readout first model parameter to the first machine learning model, and sequentially propagates the target data x₁ to the first machine learning model, thereby calculating the latent vector Sxᵢ. The first machine learning model is an encoder network that receives d-dimensional target data x₁ and outputs the d′-dimensional latent vector Sxᵢ. d′ is smaller than d. The architecture of the encoder network is not particularly limited and, for example, a deep neural network such as a ResNet (Deep Residual Learning) is used. A model parameter in the initial updating count of the representation learning processing is set to an arbitrary value. The latent vector Sxᵢ is stored in the Sx memory 21.

When step S402 is performed, the second vector calculation unit 14 calculates a latent vector Zxᵢ of non-interest of the target data x₁ using the second model parameter (step S403). In step S403, the second vector calculation unit 14 reads out the second model parameter of the training target from the storage device 2, sets the readout second model parameter to the second machine learning model, and sequentially propagates the target data xᵢ to the second machine learning model, thereby calculating the latent vector Zxᵢ of non-interest. The second machine learning model is an encoder network that receives d-dimensional target data xᵢ and outputs the d″-dimensional latent vector Zxᵢ of non-interest. d″ is smaller than d. A model parameter in the initial updating count of the representation learning processing is set to an arbitrary value. The latent vector Zxᵢ of non-interest is stored in the Zx memory 22.

When step S403 is performed, the similarity calculation unit 15 calculates the similarity S1ᵢⱼ based on the latent vector Sxᵢ and a representative value S′xⱼ thereof, and the latent vector Zxᵢ of non-interest and a representative value Z′xⱼ thereof (step S404). The suffix “j” represents a jth representative value S′x or Z′x. In step S404, the similarity calculation unit 15 acquires the representative value S′xⱼ from the Sx memory 21. The representative value S′xⱼ is a vector representing latent vectors Sx calculated until the preceding iteration count. As an example, the representative value S′xⱼ is the moving average value of the plurality of latent vectors Sx calculated until the preceding iteration count. Similarly, the similarity calculation unit 15 acquires the representative value Z′xⱼ from the Zx memory 22. The representative value Z′xⱼ is a vector representing a plurality of latent vectors Zxᵢ of non-interest calculated until the preceding iteration count. As an example, the representative value Z′xⱼ is the moving average value of the plurality of latent vectors Zxᵢ of non-interest calculated until the preceding iteration count.

In step S404, the similarity calculation unit 15 calculates the similarity S1ᵢⱼ obtained by correcting the similarity between the latent vector Sxᵢ and the representative value S′xⱼ of the latent vector Sxᵢ by the similarity between the latent vector Zx of non-interest and the representative value Z′xⱼ of the latent vector Zxᵢ of non-interest. As an example, the similarity S1ᵢⱼ is calculated in accordance with equation (1) below. The numerator of the similarity S1ᵢⱼ represents the similarity between the latent vector Sxᵢ and the representative value S′xⱼ. The denominator represents the similarity between the latent vector Zx of non-interest and the representative value Z′xⱼ. τ is a parameter for controlling the degree of enhancement of the similarity.

$$S {1}_{ij} = \frac{{s}_{{x}_{i}} {s}_{{x}_{j}}^{′}}{τexp ( - {z}_{{x}_{i}} {z}_{{x}_{j}}^{′} )} \qquad ( 1 )$$

Since the similarity Slip need only be obtained by correcting the similarity between the latent vector Sxᵢ and the representative value S′xⱼ thereof by the similarity between the latent vector Zxᵢ of non-interest and the representative value Z′xⱼ thereof, the calculation method is not limited to equation (1). For example, the similarity S1ᵢⱼ may be calculated in accordance with equation (2) below. τ′ is a parameter for controlling the degree of enhancement of the similarity of the latent vector of non-interest.

$$S {1}_{ij} = \frac{{s}_{{x}_{i}} {s}_{{x}_{j}}^{′}}{τ} \frac{{z}_{{x}_{i}} {z}_{{x}_{j}}^{′}}{{τ}^{′}} \qquad ( 2 )$$

When step S404 is performed, the second acquisition unit 12 acquires the data bᵢ of non-interest (step S405). In step S405, the second acquisition unit 12 acquires M data bᵢ of non-interest. In step S405, the second acquisition unit 12 may perform data extension for the data bᵢ of non-interest. The data extension may be the same as in step S401 or may be different processing.

FIG. 7 is a view showing an example of non-interest data corresponding to FIG. 6. As shown in FIG. 7, the non-interest data are images in which stripe patterns at various angles are drawn. Each stripe pattern is a non-interest feature. It can be said that the non-interest data is data similar to the non-interest feature of target data. Here, the non-interest data need not form a pair with target data. The non-interest data corresponds to, for example, a defect inspection image of a non-defective article in which no defective article is drawn.

When step S405 is performed, the second vector calculation unit 14 calculates a latent vector Zb of non-interest of the non-interest data b using the second model parameter (step S406). The second vector calculation unit 14 reads out the second model parameter of the training target from the storage device 2, sets the readout second model parameter to the second machine learning model, and sequentially propagates the data bᵢ of non-interest to the second machine learning model, thereby calculating a latent vector Zbᵢ of non-interest. The latent vector Zbᵢ of non-interest is stored in the Zb memory 23. In step S406, the second vector calculation unit 14 uses the same model parameter as the second model parameter used in step S403.

When step S406 is performed, the similarity calculation unit 15 calculates a similarity S2ᵢⱼ based on the latent vector Zbᵢ of non-interest and a representative value Z′bⱼ thereof (step S407). In step S407, the similarity calculation unit 15 acquires a representative value Z′b from the Zb memory 23. A representative value Z′bᵢ is a vector representing the latent vectors Zbᵢ calculated until the preceding iteration count. As an example, the representative value Z′bᵢ is the moving average value of the plurality of latent vectors Zbᵢ of non-interest calculated until the preceding iteration count. The similarity S2ᵢⱼ is calculated in accordance with equation (3) below. The numerator of the similarity S2ᵢⱼ represents the similarity between the latent vector Zbᵢ of non-interest and the representative value Z′bⱼ. The denominator τ is a parameter for controlling the degree of enhancement of the similarity.

$$S {2}_{i j} = \frac{{z}_{{b}_{i}} {z}_{{b}_{j}}^{′}}{τ} \qquad ( 3 )$$

When step S407 is performed, the similarity calculation unit 15 calculates a similarity S3ᵢⱼ between the latent vector Zxᵢ of non-interest and the representative value Z′bⱼ of a latent vector Zb of non-interest (step S408). In step S408, the similarity calculation unit 15 acquires the representative value Z′bⱼ from the Zb memory 23. The similarity S3ᵢⱼ is calculated in accordance with equation (4) below. A numerator ZxᵢZ′bⱼ represents the similarity between the latent vector Zxᵢ of non-interest and the representative value Z′bⱼ of the latent vector Zb of non-interest. The denominator τ is a parameter for controlling the degree of enhancement of the similarity.

$$S {3}_{ij} = \frac{{z}_{{x}_{i}} {z}_{{b}_{j}}^{′}}{τ} \qquad ( 4 )$$

When step S408 is performed, the loss function calculation unit 16 calculates a loss function loss including a similarity S1, a similarity S2, and a similarity S3 (step S409). As an example, the loss function loss is calculated in accordance with equation (5) below. As indicated by equation (5), the loss function loss is defined by the sum of the similarity S1, the similarity S2, and the similarity S3. The first term of equation (5) corresponds to the similarity S1. The value of the first term becomes small when the latent vector Sxᵢ of the target data x has a high similarity to S′xᵢ of itself and a low similarity to the S′xⱼ other than that, and the degree is corrected by the similarities of the latent vectors Zxᵢ and Z′xⱼ of non-interest of the target data x. The second term of equation (5) corresponds to the similarity S2. The first term plays a role of correcting the loss function loss such that the latent vector Zx of non-interest is not included in the latent vector Sx. The value of the second term becomes small when the latent vector Zbᵢ of non-interest of the non-interest data b has a high similarity to Z′bᵢ of itself and a low similarity to Z′bⱼ other than that. The second term plays a role of making the similar latent vectors Zb of non-interest close to each other and unsimilar latent vectors Zb of non-interest apart from each other. The third term of equation (5) corresponds to the similarity S3. The value of the third term becomes small when the latent vector Zxᵢ of non-interest of the target data x has a high similarity to a most similar latent vector Zbₖ of non-interest of the non-interest data b and a low similarity to other vectors. The third term plays a role of making the latent vector Zx of non-interest close to the similar latent vector Zb of non-interest and apart from the unsimilar latent vector Zb of non-interest.

$$loss = - {\sum }_{i} log ( \frac{exp ( S {1}_{ii} )}{{\sum }_{j} exp ( S {1}_{ij} )} ) - {\sum }_{i} log ( \frac{exp ( S {2}_{ii} )}{{\sum }_{j} exp ( S {2}_{ij} )} ) - {\sum }_{i} log ( \frac{exp ( S {3}_{ik} ) {\vert}_{k = {arg max}_{j} S {3}_{ij}}}{{\sum }_{j} exp ( S {3}_{ij} )} ) \qquad ( 5 )$$

The loss function loss is not limited to equation (5), and another term may be added as indicted by equation (6). The fourth, fifth, and sixth terms of equation (6) are feature decorrelation terms in Non-Patent Literature 1 (“Clustering Friendly representation learning via instance discrimination and feature decorrelation”, Yaling Tao, Kentaro Takagi, Kouta Nakata. arXiv: 2106.00131 (ICLR2021)). A feature decorrelation term L^{fd}_{Sx} represents a degree that the latent vectors Sx are orthogonal to each other. A feature decorrelation term L^{fd}_{Zx} represents a degree that the latent vectors Zx of non-interest are orthogonal to each other. A feature decorrelation term L^{fd}_{Zb} represents a degree that the latent vectors Zb of non-interest are orthogonal to each other.

$$loss = - {\sum }_{i} log ( \frac{exp ( S {1}_{i i} )}{{\sum }_{j} exp ( S {1}_{ij} )} ) - {\sum }_{i} log ( \frac{exp ( S {2}_{ii} )}{{\sum }_{j} exp ( S {2}_{ij} )} ) - {\sum }_{i} log ( \frac{exp ( S {3}_{i k} ) {\vert}_{k = {arg max}_{j} S {3}_{ij}}}{{\sum }_{j} exp ( S {3}_{i j} )} ) + {L}_{{s}_{x}}^{fd} + {L}_{{z}_{x}}^{fd} + {L}_{{z}_{b}}^{fd} \qquad ( 6 )$$

When step S409 is performed, the updating unit 17 updates the first model parameter and/or the second model parameter in accordance with the gradient of the loss function loss (step S410). In step S410, the updating unit 17 can update the model parameter using an arbitrary optimization method such as stochastic gradient descent or ADAM.

When step S410 is performed, the first vector calculation unit 13 updates the representative value S′x stored in the Sx memory 21 (step S411). In step S411, the first vector calculation unit 13 updates the representative value S′x based on the latent vector Sx calculated in step S402 in the current updating count. Typically, the representative value S′x is updated by a method such as a moving average method. As an example, when performing updating using an index moving average method, a representative value S′x^{new} after updating is calculated based on the latent vector Sx and a representative value S′x^{old} in the current updating count in accordance with an index moving average method represented by equation (7) below. The representative value S′x^{new} is stored in the Sx memory 21.

s′ₓ^{new}=αsₓ+(1−α)s′ₓ^{old} (7)

Note that the updating method is not limited only to the above-described method. As ab example, the representative value S′x^{new} after updating may be obtained by replacing a statistic value such as the average value of the latent vectors Sx calculated in step S402 of the current updating count with the representative value S x old of the current updating count.

When step S411 is performed, the second vector calculation unit 14 updates the representative value Z′x stored in the Zx memory 22 (step S412). The representative value Z′x after updating is stored in the Zx memory 22. In step S412, the second vector calculation unit 14 updates the representative value Z′x based on the latent vector Zx of non-interest calculated in step S403 of the current updating count. The representative value Z′x is updated by the same moving average method as in step S411.

When step S412 is performed, the second vector calculation unit 14 updates the representative value Z′b stored in the Zb memory 23 (step S413). The representative value Z′b after updating is stored in the Zb memory 23. In step S413, the second vector calculation unit 14 updates the representative value Z′b based on the latent vector Zb of non-interest calculated in step S406 of the current updating count. The representative value Z′b is updated by the same moving average method as in step S411.

When step S413 is performed, the learning control unit 18 determine whether the stop condition is satisfied (step S414). The stop condition is set to a condition that the updating count reaches an updating count set in advance, a condition that the value of the loss function is less than a first threshold, or a condition that the number of times when the decrease of the value of the loss function is equal to or less than a second threshold reaches a third threshold. Upon determining that the stop condition is not satisfied (NO in step S414), steps S401 to S414 are iterated for the new target data x and non-interest data b. By the iteration of steps S401 to S414, the first model parameter and/or the second model parameter can be trained such that the value of the loss function loss including the similarity S1, the similarity S2, and the similarity S3 is made small.

Upon determining in step S414 that the stop condition is satisfied (YES in step S414), the learning control unit 18 outputs the first model parameter and/or the second model parameter (step S415). The output first model parameter and/or the second model parameter is stored in the storage device 2.

When step S415 is performed, the representation learning processing according to this embodiment is ended.

The processing procedure of the above-described representation learning processing is merely an example, and addition, deletion and/or change of processing is possible without departing from the scope of the present invention.

As an example, the order of the steps shown in FIG. 4 can appropriately be changed. More specifically, the acquisition step of non-interest data (step S405) may be performed before step S404. The updating step of the representative value S′x (step S411) may be performed at any stage from the calculation step of the latent vector Sx (step S402) to the stop condition satisfaction determination step (step S414). Similarly, the updating step of the representative value Z′x (step S412) may be performed at any stage from the calculation step of the latent vector Zx of non-interest (step S402) to the stop condition satisfaction determination step (step S414), and the updating step of the representative value Z′b (step S413) may be performed at any stage from the calculation step of the latent vector Zb of non-interest (step S406) to the stop condition satisfaction determination step (step S414). The calculation step of the similarity S1 (step S404) may be performed at any stage from the calculation step of the latent vector Sx (step S402) and the calculation step of the latent vector Zx of non-interest (step S403) to the loss function calculation step (step S410). Similarly, the calculation step of the similarity S2 (step S407) may be performed at any stage from the calculation step of the latent vector Zb of non-interest (step S407) to the loss function calculation step (step S410), and the calculation step of the similarity S3 (step S408) may be performed at any stage from the calculation step of the latent vector Zx of non-interest (step S403) to the loss function calculation step (step S410).

As another example, the loss function need not include all the similarity S1, the similarity S2, and the similarity S3. For example, the loss function may include the similarity S1 and the similarity S2 but not the similarity S3. As still another example, the loss function may further include a mutual information amount between the latent vector Sx and the first latent vector Zx of non-interest.

According to the above-described representation learning processing, the first model parameter and/or the second model parameter is updated based on the loss function including the similarity S1 and the similarity S2. The similarity S1 is an index obtained by correcting the similarity between the latent vector Sx and the representative value S′x thereof by the similarity between the latent vector Zx of non-interest and the representative value Z′x thereof. The similarity S2 is an index representing the similarity between the latent vector Zb of non-interest and the representative value Z′b thereof. By using such a loss function, representation learning for enhancing an interest feature and suppressing a non-interest feature can be performed for target data including the interest feature and the non-interest feature.

Use examples of the information resource obtained by the above-described representation learning processing will be described below.

### Use Example 1

In Use Example 1, clustering based on the interest feature of the target data used in the representation learning processing according to this embodiment is executed. A post-processing unit 19 according to Use Example 1 clusters target data x based on a set of latent vectors Sx calculated by representation learning processing and stored in an Sx memory 21.

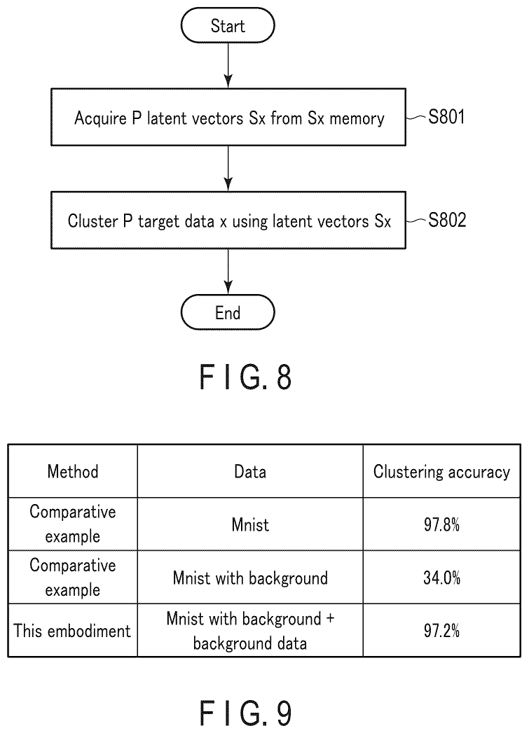

FIG. 8 is a flowchart showing the processing procedure of clustering according to Use Example 1. As shown in FIG. 8, the post-processing unit 19 acquires P latent vectors Sx from the Sx memory 21 (step S801). P is a natural number of 2 or more. The P latent vectors Sx stored in the Sx memory 21 are calculated using the first model parameter in the process of the above-described representation learning processing.

When step S801 is performed, the post-processing unit 19 clusters P target data x using the latent vectors Sx (step S802). Clustering is executed by unsupervised clustering. More specifically, clustering is executed by the K-means method. More specifically, the post-processing unit 19 initially assigns one of a plurality of labels to each of the P latent vectors Sx in the latent space (step A). For each label, the post-processing unit 19 calculates the center-of-gravity points of a plurality of latent vectors Sx belonging to the label (step B). For each of the P latent vectors Sx, the post-processing unit 19 calculates the distance from the plurality of center-of-gravity points, selects a label to which a center-of-gravity point corresponding to the shortest one of the plurality of distances belongs, and newly assigns the selected label to the latent vector Sx (step C). The post-processing unit 19 iterates the processes of steps A to C until the label assigned in step C does not change anymore. Clustering of the latent vectors Sx is thus performed. The latent vectors Sx and the target data x are in a one-to-one correspondence. For this reason, when clustering of the latent vectors Sx is performed, clustering of the target data x is also performed.

Here, the difference between clustering according to this embodiment and clustering according to a comparative example will be described. In clustering, classification is performed using the distance between latent vectors or the distance between a latent vector and the cluster center. In representation learning processing according to the comparative example, only the first vector calculation unit 13 according to this embodiment is used, and the second vector calculation unit 14 is not used. For this reason, the machine learning model learns, without distinction, both an interest feature that should be focused and a non-interest feature that should not be focused. Hence, for example, when clustering first data and second data, which have the same interest feature and different non-interest features, the first data and the second data are classified into different classes.

In the representation learning processing according to this embodiment, both the first vector calculation unit 13 and the second vector calculation unit 14 are used. It is therefore possible to obtain the first machine learning model than extracts only the interest feature that is focused and the second machine learning model that extracts only the non-interest feature that should not be focused. Hence, even when clustering first data and second data, which have the same interest feature and different non-interest features, the first data and the second data can be classified into the same class by placing focus only on the interest feature.

FIG. 9 is a view showing clustering accuracies in this embodiment and the comparative example. The comparative example shown in FIG. 9 is the method described in Non-Patent Literature 1. FIG. 9 shows the classification accuracy of a handwritten digit image data set Mnist that is open to the public and the classification accuracy of a Mnist data set with background generated by adding vertical, horizontal, and oblique stripe patterns to Mnist. Mnist is data of handwritten digits “0” to “9” and includes data of 10 classes. Mnist with background includes data of a total of 40 classes which are generated by adding four types of stripe patterns with horizontal lines, vertical lines, diagonal lines at 45°, and diagonal lines at −45° to Mnist. As the clustering accuracy, classification performance for 10 classes is shown with focus on the digits. Although the accuracy in the Mnist of the comparative example is 97.8%, the accuracy in the Mnist with background is 34.0%, that is, the performance remarkably degrades. On the other hand, the classification performance according to this embodiment is greatly improved to 97.2%.

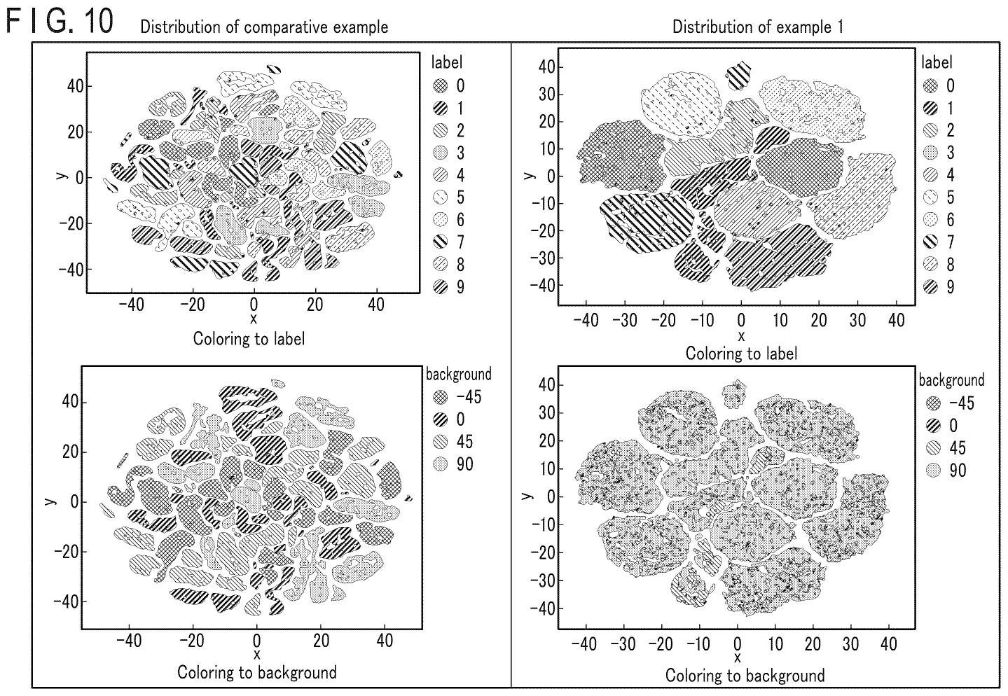

FIG. 10 is a view showing the results of compressing data distributions on latent spaces according to the embodiment and a comparative example into two dimensions and visualizing these. The comparative example shown in FIG. 10 is the method described in Non-Patent Literature 1. Each point indicates an image of target data, each hatching on the upper views indicates a digit label, and each hatching on the lower views indicates a background label. In the comparative example, data are gathered in accordance with the digit label. The data are gathered in accordance with the background label as well, and even the data of the same digit are divisionally distributed. In the latent space trained in this embodiment, data are gathered in accordance with the digit label. On the other hand, since the data are distributed independently of the background label, a latent space that includes no non-interest feature to be suppressed is learned, and the classification accuracy is expected to improve.

### Use Example 2

In Use Example 2, clustering based on an interest feature of new data x′ that is not used in the representation learning processing according to this embodiment is executed. A post-processing unit 19 according to Use Example 2 calculates a latent vector Sx′ in the latent space of the new data x′ using the first model parameter and clusters the new data x′ based on the calculated latent vector Sx′.

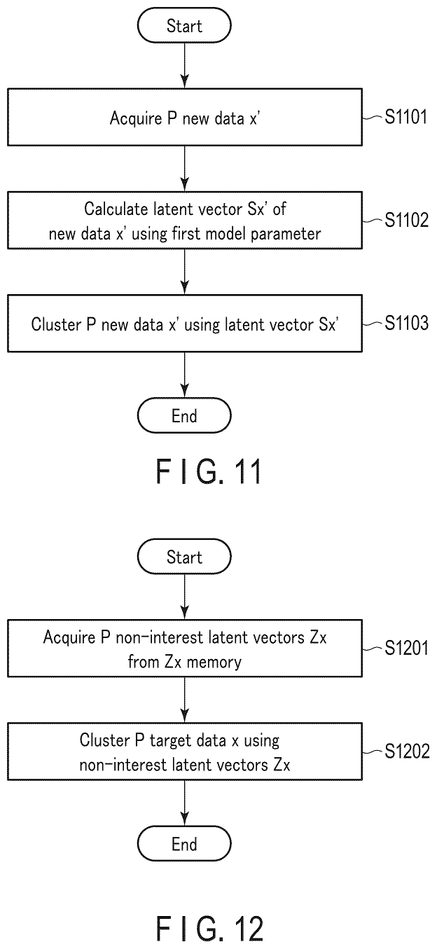

FIG. 11 is a flowchart showing the processing procedure of clustering according to Use Example 2. As shown in FIG. 11, the post-processing unit 19 acquires P new data x′ (step S1101). When step S1101 is performed, the post-processing unit 19 calculates the latent vector Sx′ of the new data x′ using the first model parameter (step S1102). When step S1102 is performed, the P new data x′ are clustered using the latent vector Sx′ (step S1103). The clustering is performed by the same method as in step S802.

According to Use Example 2, even for the new data x′ that is not used in the representation learning processing, clustering can be executed using the first model parameter trained in the representation learning processing. It is therefore possible to execute accurate clustering as compared to the comparative example.

### Use Example 3

In Use Example 3, clustering based on a non-interest feature of target data x used in the representation learning processing according to this embodiment is executed. A post-processing unit 19 according to Use Example 3 clusters the target data x based on a set of latent vectors Zx of non-interest.

FIG. 12 is a flowchart showing the processing procedure of clustering according to Use Example 3. As shown in FIG. 12, the post-processing unit 19 acquires P latent vectors Zx of non-interest from a Zx memory 22 (step S1201). The P latent vectors Zx of non-interest stored in the Zx memory 22 are calculated using the second model parameter in the process of the above-described representation learning processing. When step S1201 is performed, the post-processing unit 19 clusters the P target data x using the latent vectors Zx of non-interest (step S1202). Replacing “latent vector Sx” with “latent vector Zx of non-interest”, the clustering is performed by the same method as in step S802.

According to Use Example 3, clustering can be executed using the target data x or the latent vector Zx of non-interest used in the representation learning processing. It is therefore possible to execute accurate clustering as compared to the comparative example.

### Use Example 4

In Use Example 4, clustering based on a non-interest feature of new data x′ is executed. A post-processing unit 19 according to Use Example 4 calculates a latent vector Zx′ of non-interest in the latent space of the new data x′ using the second model parameter and clusters the new data x′ based on the calculated latent vector Zx′ of non-interest.

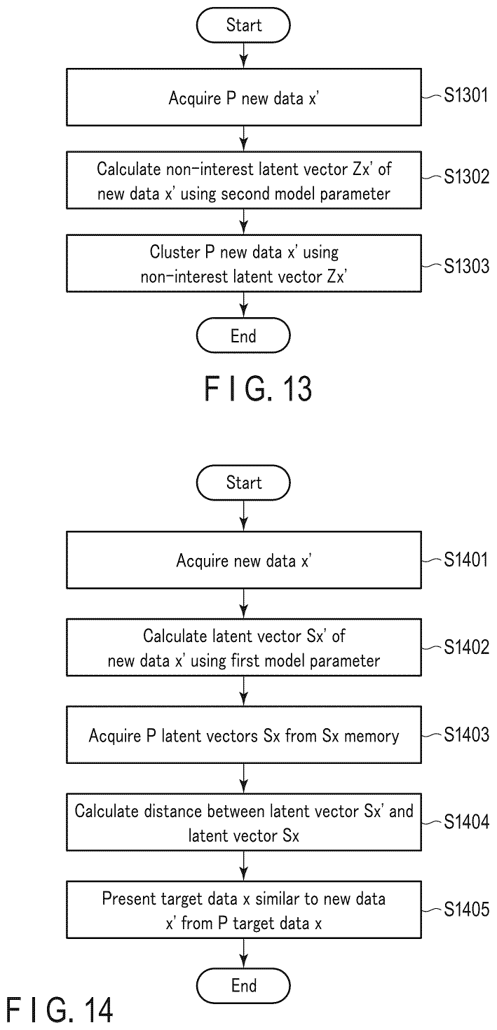

FIG. 13 is a flowchart showing the processing procedure of clustering according to Use Example 4. As shown in FIG. 13, the post-processing unit 19 acquires P new data x′ (step S1301). When step S1301 is performed, the post-processing unit 19 calculates the latent vector Zx′ of non-interest of the new data x′ using the second model parameter (step S1302). When step S1302 is performed, the P new data x′ are clustered using the latent vector Zx′ of non-interest (step S1303). Replacing “latent vector Sx” with “latent vector Zx′ of non-interest”, the clustering is performed by the same method as in step S802.

According to Use Example 4, even for the new data x′ that is not used in the representation learning processing, clustering can be executed using the second model parameter trained in the representation learning processing. It is therefore possible to execute accurate clustering as compared to the comparative example.

### Use Example 5

In Use Example 5, target data similar to new data is searched for based an interest feature. A post-processing unit 19 according to Use Example 5 calculates a new latent vector Sx′ in the latent space of new data x′ using the first model parameter, and calculates the distance or similarity between the latent vector Sx′ and a latent vector Sx. A display control unit 20 displays target data x on a display device 5 in the ascending order of distance or similarity.

FIG. 14 is a flowchart showing the processing procedure of search processing according to Use Example 5. As shown in FIG. 14, the post-processing unit 19 acquires P new data x′ (step S1401). When step S1401 is performed, the post-processing unit 19 calculates the latent vector Sx′ of the new data x′ using the first model parameter (step S1402). When step S1402 is performed, the post-processing unit 19 acquires P latent vectors Sx from an Sx memory 21 (step S1403). When step S1403 is performed, the post-processing unit 19 calculates the distance between the latent vector Sx′ and the latent vector Sx (step S1404). The distance means the difference between the latent vector Sx′ and the latent vector Sx in the latent space.

When step S1404 is performed, the display control unit 20 presents the target data x similar to the new data x′ from the P target data x (step S1405). As an example, in step S1405, the display control unit 20 displays the target data x with a distance equal to or less than a threshold on the display device 5 as the target data x similar to the new data x′. At this time, the display control unit 20 displays the target data x similar to the new data x′ in a ranking format in the ascending order of distance. As another example, the display control unit 20 may display all or a predetermined number of target data x in the ascending order of distance. Note that in steps S1404 and S1405, a similarity, a cosine similarity, or another similarity used in the above-described representation learning processing may be used in place of the distance.

According to Use Example 5, the target data x similar to the new data x′ can be searched for using the first model parameter and the latent vector Sx obtained by the representation learning processing. Hence, the accuracy of search processing is expected to improve.

### Use Example 6

In Use Example 6, another new data x′ similar to new data x is searched for based an interest feature. A post-processing unit 19 according to Use Example 6 calculates a first new latent vector Sx1′ in the latent space of first new data x1′ and a plurality of second new latent vectors Sx2′ in the latent space of a plurality of second new data x2′ using the first model parameter, and calculates the distance or similarity between each of the plurality of second new latent vectors Sx2′ and the first new latent vector Sx1′. A display control unit 20 displays the plurality of second new data x2′ on a display device 5 in the ascending order of distance or similarity.

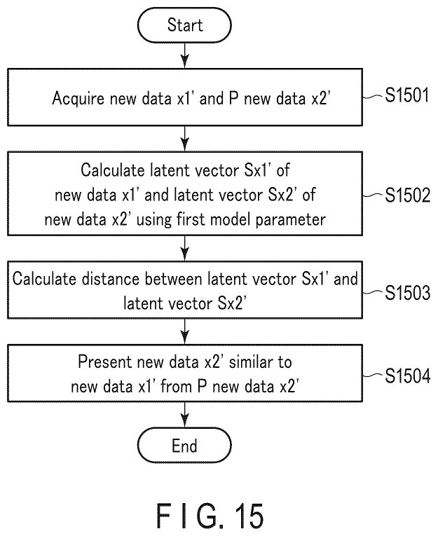

FIG. 15 is a flowchart showing the processing procedure of search processing according to Use Example 6. As shown in FIG. 15, the post-processing unit 19 acquires first new data x1′ and P second new data x2′ (step S1501). When step S1501 is performed, the post-processing unit 19 calculates the latent vector Sx1′ of the new data x1′ and the latent vector Sx2′ of the new data x₂′ using the first model parameter (step S1502). When step S1502 is performed, the post-processing unit 19 calculates the distance between the latent vector Sx1′ and the latent vector Sx2′ (step S1503). When step S1503 is performed, the display control unit 20 presents the new data x₂′ similar to the new data x1′ from the P new data x₂′ (step S1504). As the presentation method of the new data x₂′ similar to the new data x1′, the data are displayed in a ranking format, like step S1405. As in Use Example 5, a similarity may be used in place of the distance.

According to Use Example 6, the new data x2′ similar to the new data x1′ can be searched for using the first model parameter obtained by the representation learning processing. Hence, the accuracy of search processing is expected to improve.

### Use Example 7

In Use Example 7, target data similar to new data is searched for based a non-interest feature. A post-processing unit 19 according to Use Example 7 calculates a plurality of new latent vectors Zx′ of non-interest in the latent space of a plurality of new data x′ using the second model parameter, and calculates the distance or similarity between each of the plurality of new latent vectors Zx′ of non-interest and a latent vector Zx of non-interest of the target data x. A display control unit 20 displays the plurality of new data on a display device in the ascending order of distance or similarity.

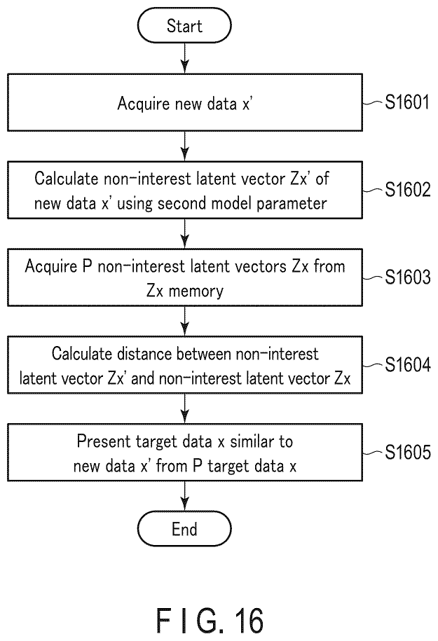

FIG. 16 is a flowchart showing the processing procedure of search processing according to Use Example 7. As shown in FIG. 16, the post-processing unit 19 acquires the new data x′ (step S1601). When step S1601 is performed, the post-processing unit 19 calculates the latent vector Sx′ of the new data x′ using a model parameter (step S1602). When step S1602 is performed, the post-processing unit 19 acquires P latent vectors Zx of non-interest from a Zx memory 22 (step S1603). When step S1603 is performed, the post-processing unit 19 calculates the distance between the latent vector Sx′ and the latent vector Zx of non-interest (step S1604). When step S1604 is performed, the display control unit 20 presents the target data x similar to the new data x′ from the P target data x (step S1605). As the presentation method of the target data x similar to the new data x′, the data are displayed in a ranking format, like step S1405. As in Use Example 5, a similarity may be calculated in place of the distance.

According to Use Example 7, the target data x similar to the new data x′ can be searched for using the second model parameter and the latent vector Zx of non-interest obtained by the representation learning processing. Hence, the accuracy of search processing is expected to improve.

### Use Example 8

In Use Example 8, another new data similar to new data is searched for based a non-interest feature. A post-processing unit 19 according to Use Example 8 calculates a first new latent vector Zx1′ of non-interest in the latent space of a non-interest feature in first new data x1′ and a plurality of second new latent vectors Zx2′ of non-interest in the latent space of a non-interest feature in a plurality of second new data x2′ using the second model parameter, and calculates the distance or similarity between each of the plurality of second new latent vectors Zx2′ of non-interest and the first new latent vector Zx1′ of non-interest. A display control unit 20 displays the plurality of second new data x2′ on a display device 5 in the ascending order of distance or similarity.

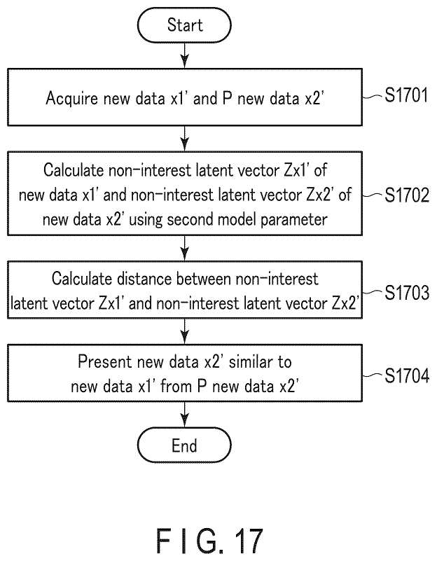

FIG. 17 is a flowchart showing the processing procedure of search processing according to Use Example 8. As shown in FIG. 17, the post-processing unit 19 acquires the first new data x1′ and P second new data x2′ (step S1701). When step S1701 is performed, the post-processing unit 19 calculates the latent vector Zx1′ of non-interest of the new data x1′ and the latent vector Zx2′ of non-interest of the new data x2′ using the second model parameter (step S1702). When step S1702 is performed, the post-processing unit 19 calculates the distance between the latent vector Zx1′ of non-interest and the latent vector Zx2′ of non-interest (step S1703). When step S1703 is performed, the display control unit 20 presents the new data x2′ similar to the new data x1′ from the P new data x2′ (step S1704). As the presentation method of the new data x2′ similar to the new data x1′, the data are displayed in a ranking format, like step S1405. As in Use Example 5, a similarity may be calculated in place of the distance.

According to Use Example 8, the new data x2′ similar to the new data x1′ can be searched for using the second model parameter obtained by the representation learning processing. Hence, the accuracy of search processing is expected to improve.

### CONCLUSION

As described above in various embodiments, the representation learning apparatus 100 includes the first acquisition unit 11, the second acquisition unit 12, the first vector calculation unit 13, the second vector calculation unit 14, the similarity calculation unit 15, the loss function calculation unit 16, and the updating unit 17. The first acquisition unit 11 acquires target data x. The second acquisition unit 12 acquires non-interest data b similar to a non-interest feature included in the target data x. The first vector calculation unit 13 calculates the latent vector Sx in the latent space of the target data x using the first model parameter concerning the first machine learning model of the training target. The second vector calculation unit 14 calculates the latent vector Zx of non-interest in the latent space of the non-interest feature included in the target data x and the latent vector Zb of non-interest in the latent space of the non-interest data b using the second model parameter concerning the second machine learning model of the training target. The similarity calculation unit 15 calculates the similarity S1 obtained by correcting the similarity between the latent vector Sx and the representative value S′x thereof by the similarity between the latent vector Zx of non-interest and the representative value Z′x thereof, and the similarity S2 between the latent vector Zb of non-interest and the representative value Z′b thereof. The loss function calculation unit 16 calculates a loss function including the similarity S1 and the similarity S2. The updating unit 17 updates the first model parameter and the second model parameter based on the loss function.

According to the above-described configuration, the first model parameter and/or the second model parameter is updated based on the loss function including the similarity S1 and the similarity S2. The similarity S1 is an index obtained by correcting the similarity between the latent vector Sx and the representative value S′x thereof by the similarity between the latent vector Zx of non-interest and the representative value Z′x thereof. The similarity S2 is an index representing the similarity between the latent vector Zb of non-interest and the representative value Z′b thereof. By using such a loss function, representation learning for enhancing a interest feature and suppressing a non-interest feature can be performed for target data including the interest feature and the non-interest feature.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A representation learning apparatus comprising a processing circuit, the processing circuit executing:
acquiring target data,
acquiring non-interest data similar to a non-interest feature included in the target data,
calculating a latent vector in a latent space of the target data using a first model parameter concerning a first machine learning model of a training target,
calculate a first non-interest latent vector in a latent space of a non-interest feature included in the target data and a second non-interest latent vector in the latent space of the non-interest data using a second model parameter concerning a second machine learning model of a training target,
calculate a first similarity obtained by correcting a similarity between the latent vector and a first representative value of the latent vector by a similarity between the first non-interest latent vector and a second representative value of the first non-interest latent vector, and a second similarity between the second non-interest latent vector and a third representative value of the second non-interest latent vector,
calculate a loss function including the first similarity and the second similarity, and
update the first model parameter and/or the second model parameter based on the loss function.

2. The apparatus according to claim 1, wherein the processing circuit calculates a third similarity between the first non-interest latent vector and the third representative value, and
calculates the loss function further including the third similarity in addition to the first similarity and the second similarity.

3. The apparatus according to claim 1, further comprising a storage device configured to store the first representative value.

4. The apparatus according to claim 3, wherein the first representative value is a moving average of a set of the latent vectors calculated by the processing circuit.

5. The apparatus according to claim 1, further comprising a storage device configured to store the second representative value.

6. The apparatus according to claim 5, wherein the second representative value is a moving average of a set of the latent vectors calculated by the processing circuit.

7. The apparatus according to claim 2, further comprising a storage device configured to store the third representative value.

8. The apparatus according to claim 7, wherein the third representative value is a moving average of a set of the second non-interest latent vectors calculated by the processing circuit.

9. The apparatus according to claim 2, wherein the processing circuit calculates the loss function further including feature decorrelation terms representing degrees that the latent vectors, the first non-interest latent vectors, and the second non-interest latent vectors are orthogonal to each other.

10. The apparatus according to claim 2, wherein the processing circuit calculates the loss function further including a mutual information amount between the latent vector and the first non-interest latent vector.

11. The apparatus according to claim 1, wherein the processing circuit further clusters the target data based on a set of the latent vectors.

12. The apparatus according to claim 1, wherein the processing circuit further calculates a new latent vector in a latent space of new data using the first model parameter, and clusters the new data based on the new latent vector.

13. The apparatus according to claim 1, wherein the processing circuit further clusters the target data based on a set of the first non-interest latent vectors.

14. The apparatus according to claim 1, wherein the processing circuit further calculates a new non-interest latent vector in a latent space of new data using the second model parameter, and clusters the new data based on the new non-interest latent vector.

15. The apparatus according to claim 1, wherein the processing circuit further
calculates a new latent vector in a latent space of new data using the first model parameter,
calculates one of a distance and a similarity between the new latent vector and the latent vector, and
displays the target data on a display device in an ascending order of the distance or the similarity.

16. The apparatus according to claim 1, wherein the processing circuit further
calculates a first new latent vector in a latent space of first new data and a plurality of second new latent vectors in a latent space of a plurality of second new data using the first model parameter,
calculates one of a distance and a similarity between each of the plurality of second new latent vectors and the first new latent vector, and
displays the plurality of second new data on a display device in an ascending order of the one of the distance and the similarity.

17. The apparatus according to claim 1, wherein the processing circuit further
calculates a plurality of new non-interest first latent vectors in a latent space of a plurality of new data using the second model parameter,
calculates one of a distance and a similarity between each of the plurality of new first non-interest latent vectors and the first non-interest latent vector, and
displays the plurality of new data on a display device in an ascending order of the one of the distance and the similarity.

18. The apparatus according to claim 1, wherein the processing circuit further
calculates a first new non-interest latent vector in a latent space of the non-interest feature in first new data and a plurality of second new non-interest latent vectors in the latent space of the non-interest feature in a plurality of second new data using the second model parameter,
calculates one of a distance and a similarity between each of the plurality of second new non-interest latent vectors and the first new non-interest latent vector, and
displays the plurality of second new data on a display device in an ascending order of the one of the distance and the similarity.

19. A representation learning method comprising:
acquiring target data;
acquiring non-interest data similar to a non-interest feature included in the target data;
calculating a latent vector in a latent space of the target data using a first model parameter concerning a first machine learning model of a training target;
calculating a first non-interest latent vector in a latent space of a non-interest feature included in the target data and a second non-interest latent vector in the latent space of the non-interest data using a second model parameter concerning a second machine learning model of a training target;
calculating a first similarity obtained by correcting a similarity between the latent vector and a first representative value of the latent vector by a similarity between the first non-interest latent vector and a second representative value of the first non-interest latent vector, and a second similarity between the second non-interest latent vector and a third representative value of the second non-interest latent vector;
calculating a loss function including the first similarity and the second similarity; and
updating the first model parameter and/or the second model parameter based on the loss function.

20. A non-transitory computer readable medium including computer executable instructions, wherein the instructions, when executed by a processor, cause the processor to perform operations comprising:
acquiring target data;
acquiring non-interest data similar to a non-interest feature included in the target data;
calculating a latent vector in a latent space of the target data using a first model parameter concerning a first machine learning model of a training target;
calculating a first non-interest latent vector in a latent space of a non-interest feature included in the target data and a second non-interest latent vector in the latent space of the non-interest data using a second model parameter concerning a second machine learning model of a training target;
calculating a first similarity obtained by correcting a similarity between the latent vector and a first representative value of the latent vector by a similarity between the first non-interest latent vector and a second representative value of the first non-interest latent vector, and a second similarity between the second non-interest latent vector and a third representative value of the second non-interest latent vector;
calculating a loss function including the first similarity and the second similarity; and
updating the first model parameter and/or the second model parameter based on the loss function.
